(19) United States
(12) Patent Application Publication
(10) Pub. No.: US 2023/0097952 A1
(43) Pub. Date: Mar. 30, 2023

(54) GARLIC PRESS HAVING A SURFACE COVERED WITH TAPERED PROJECTIONS FITTING TAPERED HOLES

(71) Applicant: Doron Cherry, Katzrin (IL)

(72) Inventor: Doron Cherry, Katzrin (IL)

(21) Appl. No.: 17/802,979

(22) PCT Filed: May 13, 2021
(86) PCT No.: PCT/IL21/50552

§ 371 Date: Aug. 29, 2022

Related U.S. Application Data
(60) Provisional application No. 63/029,723, filed on May 26, 2020.

(51) Int. Cl. A47J 19/06

(52) U.S. Cl. CPC A47J 19/06

(57) ABSTRACT

A hand operated garlic crusher, having a surface 100 covered with tapered 101, pyramidal projections fitting tapered 102 conical holes on a grating 103, which, when manually closed by the hands of the user, minces cloves of garlic and/or pushes small pieces of garlic through said tapered holes, simultaneously crushing and/or grounding the garlic, squeezing out the juice of the garlic and/or ejecting the crushed and/or ground parts and/or juice of the garlic through the grating 103.

### RELATED APPLICATION/S

This application claims the benefit of priority under 35 USC § 119(e) of U.S. Provisional Patent Application No. 63/029,723 filed 26 May 2020, the contents of which are incorporated herein by reference in their entirety.

### FIELD AND BACKGROUND OF THE INVENTION

The present invention, in some embodiments thereof, relates to a garlic press and, more particularly, but not exclusively, to a garlic press having a surface 100 covered with tapered projections 101 fitting tapered holes 102.

U.S. Patent Application No. 20120210889 appears to disclose, “An arrangement inserted into a compacting device applied in a manual garlic masher . . . more specifically, a garlic masher equipped with a compacting device that allows for total pressure to be applied to garlic bulbs contained inside a receptacle (3) by means of pressure through a plate (4) having trapezoid protuberances (5) towards holes (6) existing on the base (3a) of the receptacle (3). The perfect fit of said protuberances (5) in the holes (6), as well as the sectional format of each one of these elements allows for the total crushing and mashing of garlic bulbs, and subsequently the total elimination of the garlic mass, thus making use of the full relevant spice.”

China Patent Application No. 205410802U appears to disclose, “a press mashed garlic ware, has a plurality of hole including taking the pressure-bearing cup of handle, the last cup of taking the handle, clamp plate and pin joint arm on the bottom plate of pressure-bearing cup, have a plurality of teeth on the clamp plate, goes up cup and the pin joint of pressure-bearing cup, the roof pin joint of pin joint arm upper end and last cup, and clamp plate and pressure-bearing cup business turn over cooperation, tooth and hole cooperate, the top of going up the cup has a plurality of cutting-up teeth on the surface. Owing to adopt such structure, firstly can squeeze the mashed garlic, apron, direction are ended the position groove and are ended setting up of board of position and can guarantee that the clamp plate accuracy falls into in the pressure bearing cup, secondly, the cutting-up tooth sets up the meat that can loosen, three use the cup hammers into shape as meat, and the cutting-up tooth beats meat, cuts meat, the function is many, convenient to use.”

China Patent Application No. 102639034 appears to disclose an, “Arrangement inserted into a compacting assembly used in a manual garlic press, more particularly a garlic press (EA) equipped with a compacting assembly (1) that allows crushing garlic cloves contained inside the receptacle (3) completely by applying a pressure to a plate (4) provided with trapezoidal projections (5), moving the plate towards holes (6) in the base (3a) of the receptacle (3); the perfect fitting of said projections (5) into the holes (6), as well as the cross-sectional shape of each of these elements, makes it possible to crush and triturate the garlic cloves completely, and then to remove the garlic mass from the press completely, so that said seasoning is used in its totality.”

U.S. Patent Application No. 3327621 appears to disclose an, “invention to provide a juicer in which inserts and insets of variable types may be positioned in order to prepare vegetables and fruit juices. Another object of the present invention is to provide a pressure-type juicer which may be utilized in the home and in which the housewife may handle in a simple and effective manner. Another object of the present invention is to provide a pressure-type juicer wherein the more important parts are suited for less expensive manufacture, for example from plastic or the like. Still another object of the present invention is to provide a novel pressure-type juicer combining the aforementioned features in an aesthetically appearing body in order to enhance the marketability of the juicer while accomplishing the same at less expense than as has heretofore been possible.”

Denmark Patent Application No. 200200291 appears to disclose a, “Garlic Press.”

Additional background art includes the Spark Innovations Garlic Press Available from Spark Innovations 2189 King Road, King City Ontario, Canada L7B 1G3.

### SUMMARY OF THE INVENTION

According to an aspect of some embodiments of the invention, there is provided a method of crushing an object including: placing pieces of the object on a crushing surface including tapered projections; squeezing a handheld lever attached to the crushing surface; squeezing an opposing lever attached to a grating including tapered holes matched to the tapered projections; mincing the object between the crushing surface and the grating; and collecting juice pieces of the object.
According to some embodiments of the invention, the method further includes pushing a free end of the projections out the holes to eject the pieces.
According to some embodiments of the invention, the method further includes collecting the pieces.
According to some embodiments of the invention, the method further includes: using garlic as the object.
According to some embodiments of the invention, the method further includes: collecting at least one of extracted juice and crushed pieces of garlic in an appendage attached to the opposing handle.
According to some embodiments of the invention, the method further includes blocking movement of the grating with respect to the appendage with an interference element.
According to some embodiments of the invention, the method further includes blocking movement of the grating with respect to the opposing handle with an interference element.
According to some embodiments of the invention, the method further includes: tapered projections including multiple tapering angles.
According to some embodiments of the invention, the method further includes: tapered projections having pyramidal shapes.
According to some embodiments of the invention, the method further includes: holes of the grating having conical shapes.
According to some embodiments of the invention, the method further includes: holes of the grating including pyramidal shapes.
According to some embodiments of the invention, the method further includes: slicing pieces of garlic without crushing them.
According to some embodiments of the invention, the method further includes: squeezing pasta dough.
According to an aspect of some embodiments of the invention, there is provided a method of crushing an object including: placing pieces of the object on a surface covered with tapered projections; pushing a plunger top attached to the surface covered with tapered projections into a barrel of an injector and onto a grating, including tapered holes into which the tapered projections fit, attached to an adaptor of the injector; simultaneously crushing the object; collecting juice extracted from the object; and collecting crushed and/or ground pieces of the object.
According to an aspect of some embodiments of the invention, there is provided an object crushing system including: a crushing surface with tapered projections; a handheld lever attached to the crushing surface; a grating including tapered holes matching the tapered projections; an opposing handheld lever attached to the grating; and a fulcrum rotatably connected the handheld lever and the opposing handheld lever such that squeezing the handheld lever towards the opposing handheld lever pushes the crushing surface toward the grating and the tapered projections into the tapered holes.
According to some embodiments of the invention, the tapered projections include multiple tapering angles.
According to some embodiments of the invention, the tapered projections have pyramidal shapes.
According to some embodiments of the invention, the holes are conical shaped.
According to some embodiments of the invention, the holes of the grating comprise conical shaped projections.
According to some embodiments of the invention, the holes of the grating comprise pyramidal shaped projections.
According to some embodiments of the invention, the crushing surface and grating are configured to crush garlic.
According to some embodiments of the invention, the crushing surface and grating are configured to extract juice from the crushed object.
According to some embodiments of the invention, the crushing surface and grating are configured to eject pieces of the crushed object through the grating.
According to some embodiments of the invention, the projections at least as long as the holes to eject pieces of the crushed object through the grating.
According to some embodiments of the invention, the crushing surface and grating are configured to slice the object placed on the crushing surface.
According to some embodiments of the invention, the object crushing system further includes: a plunger top attached to the surface covered with tapered projections; a barrel of an injector; and an adaptor of the injector attached to the grating.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a side perspective view of a garlic press, in an open position, having a surface covered with tapered projections fitting tapered holes;

FIG. 2 is a top perspective view of a garlic press, in an open position, having a surface covered with tapered projections fitting tapered holes;

FIG. 3 is a side view of a garlic press, in a closed position, having a surface covered with tapered projections fitting tapered holes;

FIG. 4 is a top view of the crushing surface of a garlic press, in a closed position, having a surface covered with tapered projections fitting tapered holes;

FIG. 5 is a top view of a garlic press, in a closed position, having a surface covered with tapered projections fitting tapered holes;

FIG. 6 is a side perspective view of a garlic press, in a closed position, having a surface covered with tapered projections fitting tapered holes;

FIG. 7 is a side view of a garlic press, in an open position, having a surface covered with tapered projections fitting tapered holes;

FIG. 8 is a top plan view of the crushing surface of a garlic press, in an open position, having a surface covered with tapered projections fitting tapered holes;

FIG. 9 is a top view of a garlic press, in a closed position, having a surface covered with tapered projections fitting tapered holes;

FIG. 10 is a top view of a garlic press, in a closed position, having a surface covered with tapered projections fitting tapered holes;

FIG. 11 is a side perspective view of a garlic press, in an open position, having a surface covered with tapered projections fitting tapered holes;

FIG. 12 is an exemplary block diagram illustrating the relationship between the components of a garlic press having a surface covered with tapered projections fitting tapered holes;

FIG. 13 is a flow chart illustration of a method of pressing garlic with a garlic press having a surface covered with tapered projections fitting tapered holes;

FIG. 14 is an exploded view of a garlic crusher in accordance with an embodiment of the current invention;

FIG. 15 is a perspective view of a closed garlic crusher in accordance with an embodiment of the current invention; and

FIG. 16 is a close up orthogonal view of a closed garlic crusher in accordance with an embodiment of the current invention.

### DESCRIPTION OF SPECIFIC EMBODIMENTS OF THE INVENTION

The present invention, in some embodiments thereof, relates to a garlic press and, more particularly, but not exclusively, to a garlic press having a surface 100 covered with tapered projections 101 fitting tapered holes 102.

An aspect of some embodiments of the current invention relates to a garlic press including a crushing surface having tapered projections that fit into tapered holes of grating. Optionally, the projections pushing small pieces of garlic through the tapered hole and simultaneously crush the pieces to extract juice. In some embodiments, the juice and the crushed garlic are ejected through the grating. Optionally, the tapered projections are shaped to cover the entire surface of the crushing lid (for example pyramidal shapes). Optionally, the press is configured for one-handed operation. In some embodiments, the grating is retractable for cleaning. For example, the grating may be mounted on a hinge and/or a rotate forward to a stop for crushing and/or back for cleaning. Optionally, a lever am) and/or a crushing plate and/or the grating may be rotate independently around a single fulcrum.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

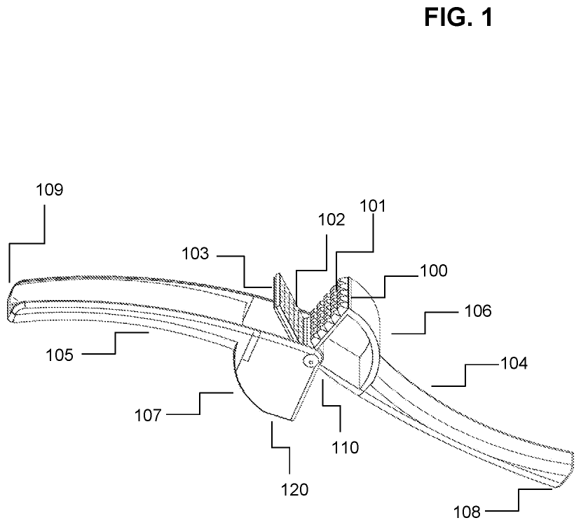

Referring now to the drawings, FIG. 1 is a side perspective view of a garlic press, in an open position. In some embodiments a lever 104 of the garlic press includes a crushing surface 100. Optionally, said crushing surface 100 comprises tapered projections 101. Optionally, said tapered projections 101 fit into the holes of a grating 103 on an opposing lever 105. Optionally, said holes of the grating 103 are tapered holes 102. Additionally, or alternatively, said tapered projections 101 have multiple tapering angles.

In some embodiments the lever 104 is curved. Optionally, said curvature increases the comfort of the user and/or the ease of moving the lever 104 when closing the garlic press. In some embodiments the opposing lever 105 is curved. Optionally, said curvature increases the comfort of the user and/or the ease of moving the opposing lever 105 when closing the garlic press.

In some embodiments the lever 104 comprises an appendage 106 that protrudes out from the lever 104 in the shape of a quarter circle and attaches to the outer end of the crushing surface 100. Optionally, said appendage 106 stabilizes the crushing surface 100. In some embodiments the opposing lever 105 comprises an appendage 107 that protrudes out from the opposing lever 105 in the shape of a quarter circle and attaches to the outer end of the grating 103. Optionally, the appendage 107 stabilizes the grating 103. Optionally the appendage includes a hollow space. For example, cloves of garlic and/or other material to be minced are positioned in the hollow of appendage 107. For example, surface 100 passes through the space and/or crushes objects in that space against the grating 103. For example, surface 100 fits snugly to the space and/or rotates around a fulcrum 110 which may also be an axis of the quarter circle.

In some embodiments, pieces of garlic (most preferably whole cloves and/or cut pieces) are placed between the crushing surface 100 and grating 103. Optionally, the hollow of the appendage 107 is sized to fit pieces of garlic that are less than 2 cubic cm in volume and/or that are whose longest dimension is less than 2 cm and/or less than 1.5 cm and/or less than 3 cm. Optionally, said pieces of garlic are less than 1 cubic cm in volume. Optionally, said pieces of garlic are less than 0.5 cubic cm in volume. For example, the grating 103 and/or the crushing surface may have a width and/or length of between 1 to 4 cm and/or between 0.2 and 1 cm and/or between 4 to 10 cm.

In some embodiments the movement of one or both levers 104 and/or 105 in a manner that brings the end 108 of the lever 104 closer to the end 109 of the opposing lever 105 causes the tapered projections 101 on the crushing surface 100 to enter the tapered holes 102 on the grating 103. For example, the taper on the projections 101 and/or tapers of the holes 102 may help align the surface 100 and the grating 103. For example, even if the alignment is slightly off, the tapered end of the projections 101 will fit into the large side of holes 102 and/or as the device is closed the taper will cause the surface 100 to align with the grating 103. Optionally, said movement minces the garlic. For example, the garlic may be broken into small pieces and/or the small pieces of garlic as it is initially pushed against the grating 103. Optionally, the pieces may be crushed and/or pushed through said tapered holes 102 as the projections 101 are pushed into the holes 102. Optionally, a fulcrum 110 holds the lever 104 and the opposing lever 105 in place as they move toward and/or away from each other. Preferably the minced garlic is collected. For example, the minced garlic may include ground and/or crushed pieces and/or extracted juice. For example, the minced garlic may be ejected through the grating and/or collected.

In some embodiments, said movement simultaneously crushes and/or grinds one or more said pieces of garlic. Optionally, said crushing and/or grounding of pieces of garlic causes the juice of the garlic to be extracted from the garlic. Additionally, or alternatively, said crushing of pieces of garlic causes the ejection of crushed and/or ground pieces through the grating 103.

In some embodiments the extracted juice is collected. Optionally, the extracted juice falls from the garlic press as the juice is extracted. Optionally, the extracted juice falling from the garlic press is collected in a vessel and/or mixed with the rest of the crushed and/or ground garlic. Additionally, or alternatively, some or all of the extracted juice and/or pieces of garlic collects in the appendage 107 of the opposing lever 105.

In some embodiments, crushed and/or ground pieces ejected through the grating 103 are collected. Optionally, crushed and/or ground pieces ejected through the grating 103 are collected in a vessel. Additionally, or alternatively, crushed and/or ground pieces ejected through the grating 103 are collected in the appendage 107 of the opposing lever 105. Optionally, appendage 107 of the opposing lever 105 is attached to the grating 103.

In some embodiments said tapered projections 101 cover the entire crushing surface 100. Optionally, said tapered projections 101 are shaped to cover the entire crushing surface 100. For example, said tapered projections 101 may have a pyramidal shape covering the entire crushing surface 100. Alternatively or additionally, the projections may cover more than 95% of the surface and/or more than 90% of the surface and/or more than 80% of the surface and/or more than 60% of the surface.

In some embodiments the holes of the grating 103 have conical shapes. Additionally, or alternatively, said holes of said grating 103 have conical projections.

In some embodiments tapered projections and tapered holes are similar to those used in injectors. For example, the tapered projections and tapered holes may be used in hypodermic needles and/or injection molds and/or injectors for injection molds. Optionally, an injector top optionally comprises a crushing surface covered with tapered projections. Optionally, an adaptor of the injector comprises a grating. Optionally, the grating comprises tapered holes into which the tapered projections fit. Optionally, an application of force to the plunger top forces the plunger top down into the barrel of the injector, causing an object placed on the grating to be pushed into the holes of the grating.

In some embodiments the tapered projections cover the entire crushing surface. Optionally, said tapered projections are shaped to cover the entire crushing surface. For example, said tapered projections may have a pyramidal shape covering the entire crushing surface.

In some embodiments the holes of the grating have conical shapes. Additionally, or alternatively, said holes of said grating have conical projections.

In some embodiments tapered holes are configured to fit the tapered projections. For example, the holes may be pyramidal. In some embodiments said tapered holes cover the entire crushing surface. For example, said tapered holes may have a pyramidal shape covering the entire crushing surface. Alternatively or additionally, the holes may cover more than 95% of the surface and/or more than 90% of the surface and/or more than 80% of the surface and/or more than 60% of the surface.

Optionally a tapered hole ends in an opening. The opening may be smaller than the tapered portion of the hole and/or the tapered portion may end in an opening (e.g. the hole may have a shape of a cut off conic and/or pyramidal section with openings at each end). Optionally, when the crusher is closed, part the projection will protrude out the opening. The base of the pyramid may have any shape (rectangle, circle, triangle, hexagon, star etc.) The tapered may straight and/or oblique in its orientation. All of the projections and/or holes may have the same geometry. Alternatively or additionally, some of the projection and/or projections may differ in geometry.

In a preferable embodiment, minced garlic including pieces of garlic, crushed garlic, garlic paste and/or juice is extracted through the grating and/or collected.

In some embodiments juice extracted from the object placed on the grating is extracted through the injector. Optionally, the extracted juice is collected in a vessel.

In some embodiments the projections on the crushing surface cause an increase in pressure at the point of contact with the object being crushed as compared to an injection without said projections. Optionally, the pressure increase is amplified by the shape of the projections and/or holes. For example, conically shaped projections of the holds and/or pyramidally shaped projections may amplify the pressure increase.

In some embodiments the garlic press is held in the hand of the user during use. For example, the garlic press may act as a handheld crusher. Optionally, the handheld crusher is operated in a wave like format. Additionally, or alternatively, said garlic press is placed on a flat surface, such as a table, during use.

In some embodiments the garlic press slices slices the pieces of garlic without crushing them. In some embodiments the press minces ginger and/or squeezes pasta dough. Optionally, the press produces pasta.

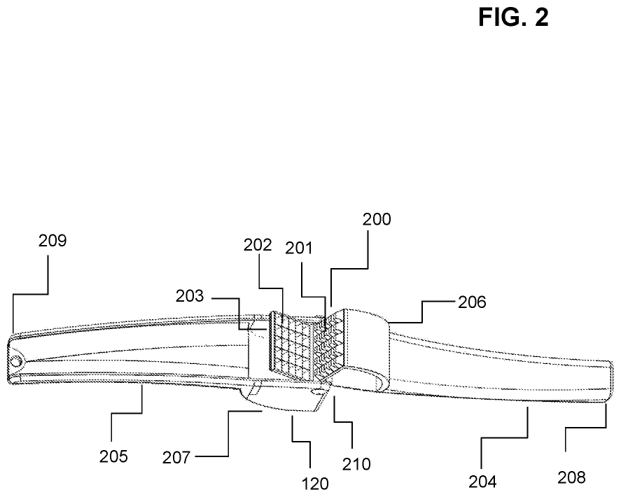

FIG. 2 is a top perspective view of a garlic press, in an open position, having a surface covered with tapered projections fitting tapered holes. In some embodiments a lever 204 of the garlic press includes a crushing surface 200. Optionally, said crushing surface 200 comprises tapered projections 201. Optionally, said tapered projections 201 fit into the holes of a grating 203 on an opposing lever 205. Optionally, said holes of the grating 203 are tapered holes 202.

In some embodiments the lever 204 comprises an appendage 206 that protrudes out from the lever 204 in the shape of a quarter circle and attaches to the outer end of the crushing surface 200. In some embodiments the opposing lever 205 comprises an appendage 207 that protrudes out from the opposing lever 205 in the shape of a quarter circle and attaches to the outer end of the grating 203.

In some embodiments the movement of one or both levers 204 and/or 205 in a manner that brings the end 208 of the lever 204 closer to the end 209 of the opposing lever 205 causes the tapered projections 201 on the crushing surface 200 to enter the tapered holes 202 on the grating 203. Optionally, a fulcrum 210 holds the lever 204 and the opposing lever 205 in place as they move toward and/or away from each other.

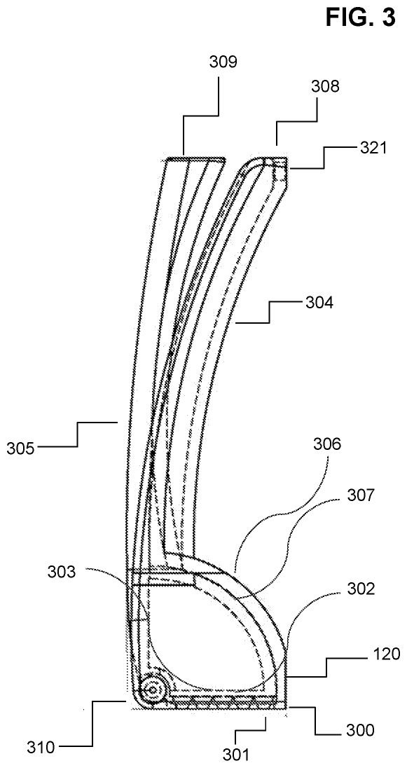

FIG. 3 is a side view of a garlic press, in a closed position, having a surface covered with tapered projections fitting tapered holes. In some embodiments a lever 304 of the garlic press includes a crushing surface 300. Optionally, said crushing surface 300 comprises tapered projections 301. Optionally, said tapered projections 301 fit into the holes of a grating 303 on an opposing lever 305. Optionally, said holes of the grating 303 are tapered holes 302.

In some embodiments the lever 304 comprises an appendage 306 that protrudes out from the lever 304 in the shape of a quarter circle and attaches to the outer end of the crushing surface 300. In some embodiments the opposing lever 305 comprises an appendage 307 that protrudes out from the opposing lever 305 in the shape of a quarter circle and attaches to the outer end of the grating 303.

In some embodiments the movement of one or both levers 304 and/or 305 in a manner that brings the end 308 of the lever 304 closer to the end 309 of the opposing lever 305 pushes the crushing surface 300 towards the grating 303. Optionally, an element of the appendage includes a feature (e.g., an interference feature, for example a ledge) that blocks movement (for example rotation around fulcrum 110) of the grating 103. Optionally, when movement of the grating is blocked, the tapered projections 301 on the crushing surface 300 to enter the tapered holes 302 on the grating 303. Optionally, a fulcrum 310 holds the lever 304 and the opposing lever 305 in place as they move toward and/or away from each other.

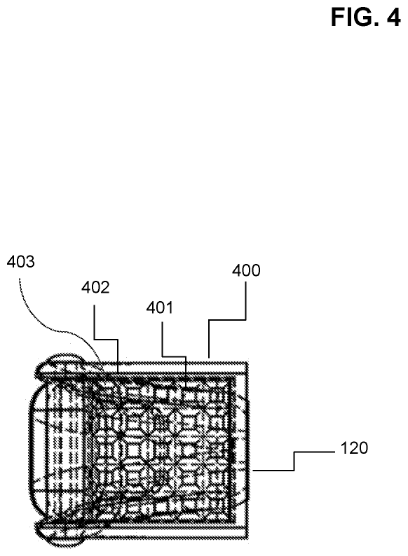

FIG. 4 is a top view of the crushing surface of a garlic press, in a closed position, having a surface covered with tapered projections fitting tapered holes. In some embodiments the crushing surface 400 comprises tapered projections 401. Optionally, said tapered projections 401 fit into the holes of a grating 403. Optionally, said holes of the grating 403 are tapered holes 402.

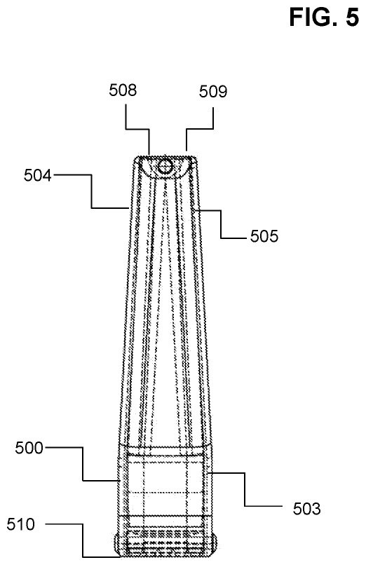

FIG. 5 is a top view of a garlic press, in a closed position, having a surface covered with tapered projections fitting tapered holes. In some embodiments a lever 504 of the garlic press includes a crushing surface 500. Optionally, said crushing surface 500 comprises tapered projections. Optionally, said tapered projections fit into the holes of a grating 503 on an opposing lever 505. Optionally, said holes of the grating 503 are tapered holes.

In some embodiments the movement of one or both levers 504 and/or 505 in a manner that brings the end 508 of the lever 504 closer to the end 509 of the opposing lever 505 causes the tapered projections 501 on the crushing surface 500 to enter the tapered holes 502 on the grating 503. Optionally, a fulcrum 510 holds the lever 504 and the opposing lever 505 in place as they move toward and/or away from each other.

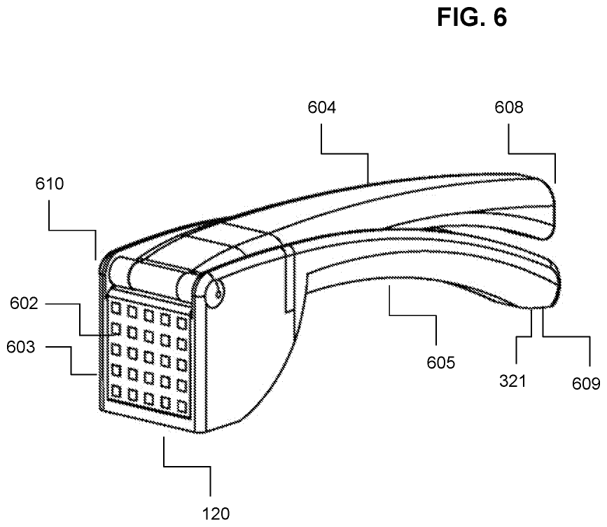

FIG. 6 is a side perspective view of a garlic press, in a closed position, having a surface covered with tapered projections fitting tapered holes. In some embodiments a lever 604 of the garlic press includes a crushing surface. Optionally, said crushing surface comprises tapered projections. Optionally, said tapered projections fit into the holes of a grating 603 on an opposing lever 605. Optionally, said holes of the grating 603 are tapered holes 602.

In some embodiments the movement of one or both levers 604 and/or 605 in a manner that brings the end 608 of the lever 604 closer to the end 609 of the opposing lever 605 causes the tapered projections on the crushing surface to enter the tapered holes 602 on the grating 603. Optionally, a fulcrum 610 holds the pivot points of lever 604 and the opposing lever 605 in place as the levers 604 and/or 605 moves toward and/or away from each other.

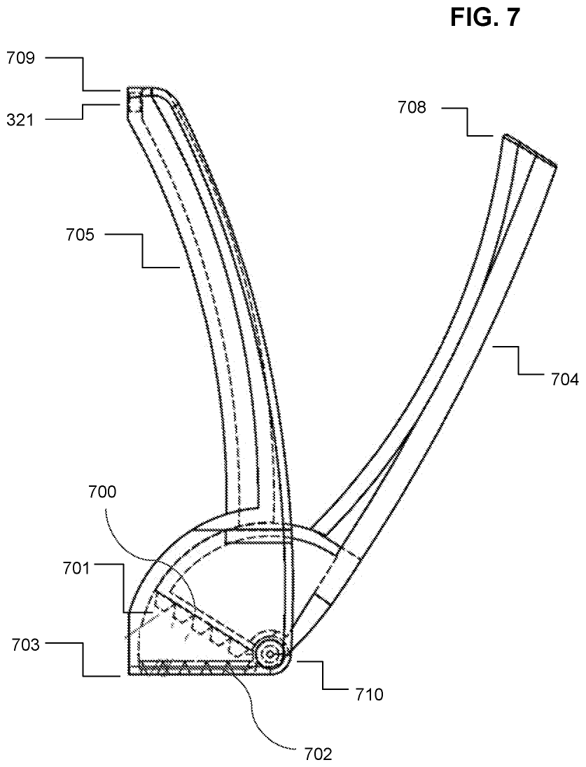

FIG. 7 is a side view of a garlic press, in an open position, having a surface covered with tapered projections fitting tapered holes. In some embodiments a lever 704 of the garlic press includes a crushing surface 700. Optionally, said crushing surface 700 comprises tapered projections 701. Optionally, said tapered projections 701 fit into the holes of a grating 703 on an opposing lever 705. Optionally, said holes of the grating 703 are tapered holes 702.

In some embodiments the movement of one or both levers 704 and/or 705 in a manner that brings the end 708 of the lever 704 closer to the end 709 of the opposing lever 705 causes the tapered projections 701 on the crushing surface 700 to enter the tapered holes 702 on the grating 703. Optionally, a fulcrum 710 holds the lever 704 and the opposing lever 705 in place as they move toward and/or away from each other.

Optionally the crusher is configured to allow it be used sitting on a surface. For example, a surface 321 on the handle may have a flat section and/or may be parallel to a flat section 120 on the outer surface of the crushing chamber such that the crusher sits stably on a flat surface, for example a table top. Alternatively or additionally, a base may be supplied for supporting the crusher on a flat surface. For example, that crusher may be stable enough on the surface to place the bottom surface 120 and 321 on a table and crush the garlic (or another object) by pushing down on the upper handle (e.g., with one hand).

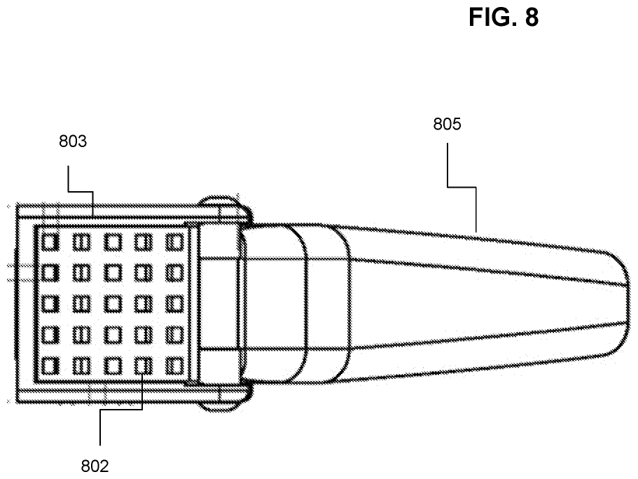

FIG. 8 is a top plan view of the crushing surface of a garlic press, in an open position, having a surface covered with tapered projections fitting tapered holes. In some embodiments a lever of the garlic press includes a crushing surface. Optionally, said crushing surface comprises tapered projections. Optionally, said tapered projections fit into the holes of a grating 803 on an opposing lever 805. Optionally, said holes of the grating 803 are tapered holes 802.

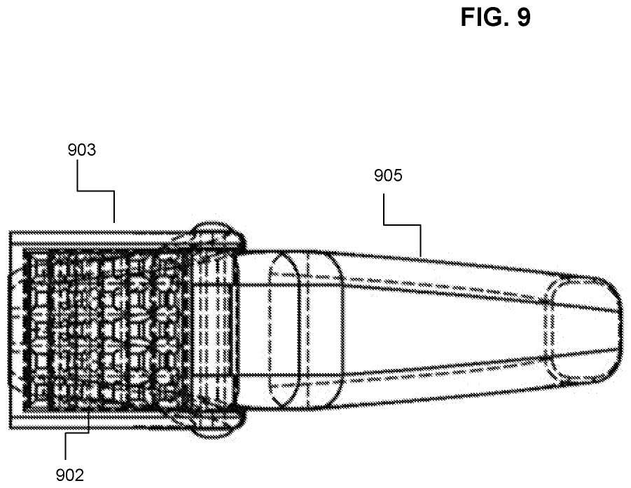

FIG. 9 is a top view of a garlic press, in a closed position, having a surface covered with tapered projections fitting tapered holes. In some embodiments a lever of the garlic press includes a crushing surface. Optionally, said crushing surface comprises tapered projections. Optionally, said tapered projections fit into the holes of a grating 903 on an opposing lever 905. Optionally, said holes of the grating 903 are tapered holes 902.

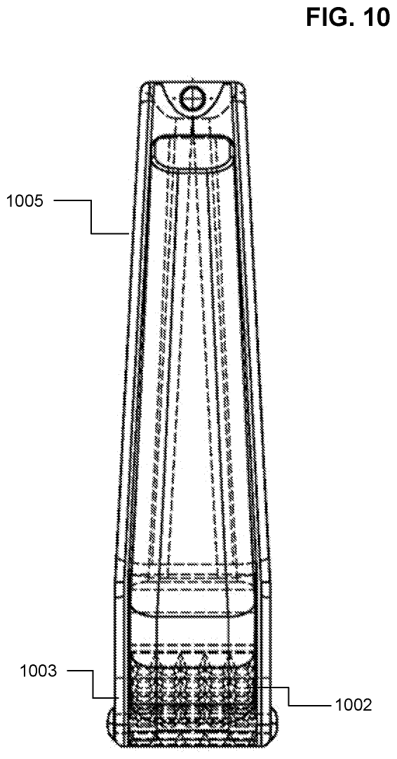

FIG. 10 is a top view of a garlic press, in a closed position, having a surface covered with tapered projections fitting tapered holes. In some embodiments a lever of the garlic press includes a crushing surface. Optionally, said crushing surface comprises tapered projections. Optionally, said tapered projections fit into the holes of a grating 1003 on an opposing lever 1005. Optionally, said holes of the grating 1003 are tapered holes 1002.

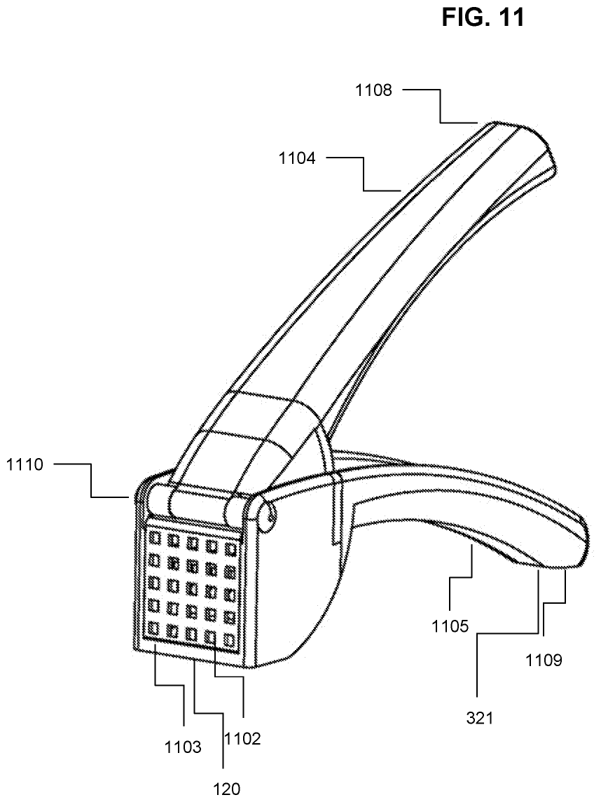

FIG. 11 is a side perspective view of a garlic press, in an open position, having a surface covered with tapered projections fitting tapered holes. In some embodiments a lever 1104 of the garlic press includes a crushing surface. Optionally, said crushing surface comprises tapered projections. Optionally, said tapered projections fit into the holes of a grating 1103 on an opposing lever 1105. Optionally, said holes of the grating 1103 are tapered holes 1102.

In some embodiments the movement of one or both levers 1104 and/or 1105 in a manner that brings the end 1108 of the lever 1104 closer to the end 1109 of the opposing lever 1105 causes the tapered projections on the crushing surface to enter the tapered holes 1102 on the grating 1103. Optionally, a fulcrum 1110 holds the lever 1104 and the opposing lever 1105 in place as they move toward and/or away from each other.

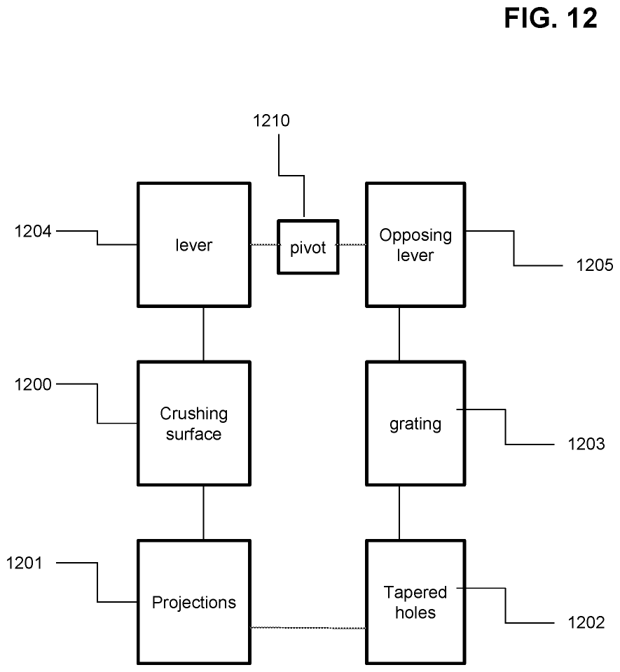

FIG. 12 is an exemplary block diagram illustrating the relationship between the components of a garlic press having a surface covered with tapered projections fitting tapered holes. In some embodiments a lever 1204 of the garlic press includes a crushing surface 1200. Optionally, said crushing surface 1200 comprises tapered projections 1201. Optionally, said tapered projections 1201 fit into the holes of a grating 1203 on an opposing lever 1205. Optionally, said holes of the grating 1203 are tapered holes 1202.

In some embodiments the movement of one or both levers 1204 and/or 1205 in a manner that brings the end of the lever 1204 closer to the end of the opposing lever 1205 causes the tapered projections 1201 on the crushing surface 1200 to enter the tapered holes 1202 on the grating 1203. Optionally, a fulcrum 1210 holds the lever 1204 and the opposing lever 1205 in place as they move toward and/or away from each other.

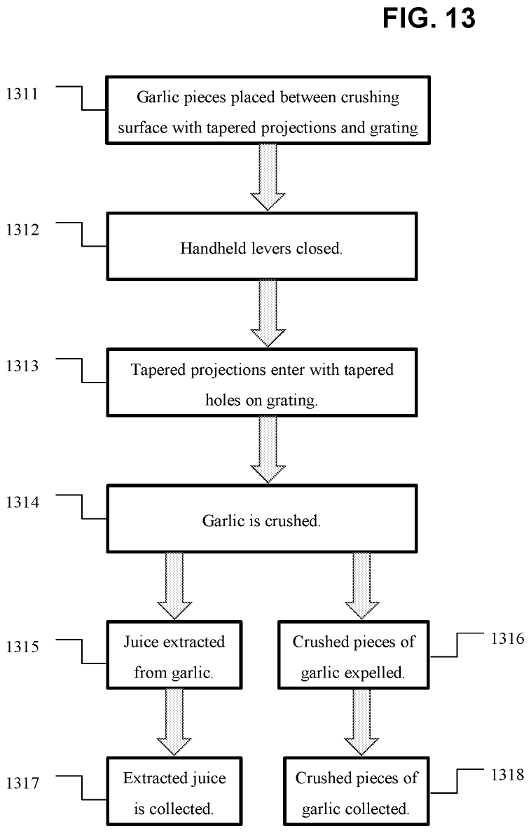

FIG. 13 is a flow chart illustration of a method of pressing garlic with a garlic press having a surface covered with tapered projections fitting tapered holes. In some embodiments, pieces of garlic (e.g., cloves of garlic) are placed between a crushing surface covered with tapered projections 1311 and a grating. For example, the pieces may be placed in a hollow appendage. Optionally, a handheld lever attached to the crushing surface is brought closer to an opposing lever attached to a grating comprising tapered holes into which the tapered projections fit 1312. Optionally, the action of bringing the levers closer to each other causes the tapered projections to enter the tapered holes on the grating 1313. Optionally, the action of the insertion of the tapered projections into the tapered holes on the grating crushes cloves of garlic located on the crushing surface 1314. Optionally, minced garlic is pushed out the grating and/or collected. Alternatively or additionally, juice is extracted from the garlic as a result of the crushing of the garlic 1315. Optionally, crushed and/or ground pieces of garlic are expelled as a result of the crushing of the garlic 1316. Optionally, the extracted juice is collected 1317. Additionally, or alternatively, the crushed and/or ground pieces of garlic are collected 1318.

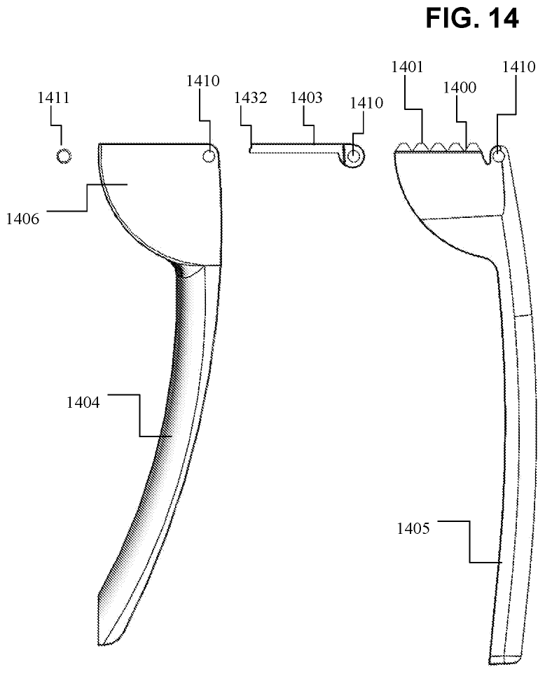

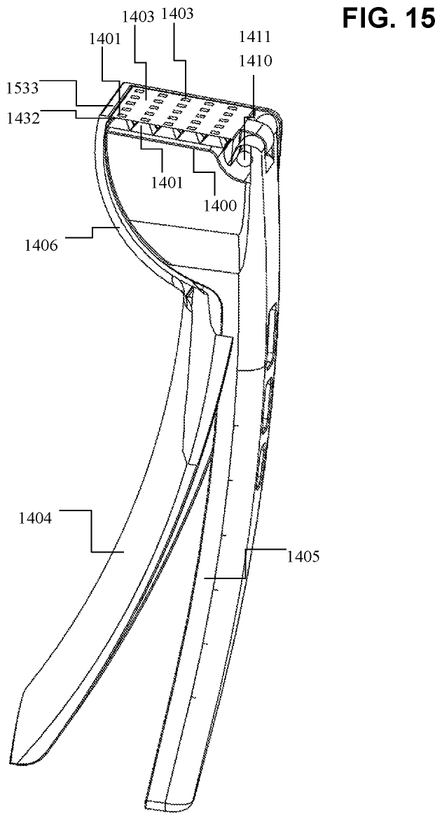

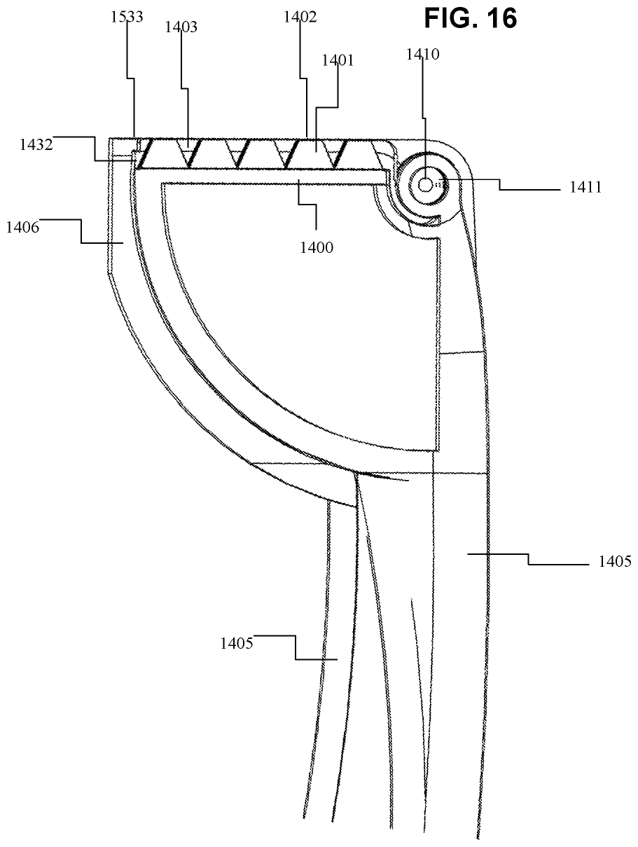

FIG. 14 is an exploded view of a garlic crusher in accordance with an embodiment of the current invention. FIG. 15 is a perspective view of a closed garlic crusher in accordance with an embodiment of the current invention. FIG. 16 is a close up orthogonal view of a closed garlic crusher in accordance with an embodiment of the current invention. For example, the crusher may include an axle 1411 joining two handles 1404, 1405, a grating 1403 and/or a crushing plate 1400 at a fulcrum 1410. For example, crushing plate 1400 may move with and/or be rigidly attached to arm 1405 and/or appendage 1406 may move with and/or be rigidly attached to arm 1404. Optionally, the crushing plate 1400 includes tapered teeth (e.g., projections 1401). For example, the tapered teeth may fit tapered holes 1402 (e.g., as illustrated in FIG. 15) in the grating 1403.

In some embodiments, grating 1403 includes an interference feature 1432 which interacts with another interference feature (e.g., a protrusion 1533 on appendage 1406 for example as is seen in FIG. 16). For example, interaction between the interference features 1432, 1533 may block movement of the grating 1403 with respect to the appendage 1406 and/or the arm 1404. In some embodiments, as arm 1405 is brought together with arm 1404, crushing plate 1400 moves with arm 1405 and/or is forced against grating 1403. For example, grating 1403 may be held stationary by with respect to arm 1404 by inference elements 1533, 1432. Optionally, the projections 1401 may be matched with the holes 1402 such that when the crusher is closed (e.g., arm 1404 is pushed towards arm 1405) projections 1401 fit into holes 1402. Additionally or alternatively, projections 1401 may be pushed into holes 1402 in the grating 1403. In some embodiment, projections 1401 may fit very closely (substantially exactly e.g., to less than 0.1 mm tolerance and/or less than 0.01 mm tolerance). For example, the close fit between projection 1401 and holes 1402 may cause the pieces of the garlic to be cut off and/or ejected out the front of grating 1403. Alternatively or additionally, projections 1401 may fit very loosely (e.g., with space of more than 0.1 mm and/or more than 1 mm). For example, the loose fit between projection 1401 and holes 1402 may cause some of the pieces of the garlic to be retained and/or more juice to be ejected out the front of grating 1403. In some embodiments, projections 1401 may be shorted than holes 1402 (e.g., such that when the crusher is closed, there may remain an empty space at the outer end of holes 1402 in which pieces of garlic may be retained). Alternatively or additionally, projections 1401 may be as long as or longer than holes 1402 (e.g., such that when the crusher is closed, the outer free end of projections 1401 may reach and/or extend out the outer end of holes 1402 ejected pieces of garlic).

It is expected that during the life of a patent maturing from this application many relevant technologies will be developed and the scope of the terms used herein is intended to include all such new technologies a priori.

As used herein the term “about” refers to ±5%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of crushing an object comprising:
placing pieces of the object on a crushing surface including tapered projections;
squeezing a handheld lever attached to the crushing surface;
squeezing an opposing lever attached to a grating including tapered holes matched to the tapered projections;
mincing the object between the crushing surface and the grating; and
collecting juice pieces of the object.

2. The method of claim 1, further comprising pushing a free end of said projections out said holes to eject said pieces.

3. The method of claim 1, further comprising collecting said pieces.

4. The method of claim 1, further comprising:
using garlic as the object.

5. The method of claim 1, further comprising:
collecting at least one of extracted juice and crushed pieces of garlic in an appendage attached to said opposing handle.

6. The method of claim 5, further comprising blocking movement of said grating with respect to said appendage with an interference element.

7. The method of claim 1, further comprising blocking movement of said grating with respect to said opposing handle with an interference element.

8. The method of claim 1, further comprising:
tapered projections comprising multiple tapering angles.

9. The method of claim 1, further comprising:
tapered projections having pyramidal shapes.

10. The method of claim 1, further comprising:
holes of the grating having conical shapes.

11. The method of claim 1, further comprising:
holes of the grating comprising pyramidal shapes.

12. The method of claim 1, further comprising:
slicing pieces of garlic without crushing them.

13. The method of claim 1, further comprising:
squeezing pasta dough.

14. A method of crushing an object comprising:
placing pieces of the object on a surface covered with tapered projections;
pushing a plunger top attached to the surface covered with tapered projections into a barrel of an injector and onto a grating, comprising tapered holes into which the tapered projections fit, attached to an adaptor of the injector;
simultaneously crushing the object;
collecting juice extracted from the object; and
collecting crushed and/or ground pieces of the object.

15. An object crushing system comprising:
a crushing surface with tapered projections;
a handheld lever attached to the crushing surface;
a grating comprising tapered holes matching the tapered projections;
an opposing handheld lever attached to the grating; and
a fulcrum rotatably connected the handheld lever and the opposing handheld lever such that squeezing the handheld lever towards the opposing handheld lever pushes the crushing surface toward the grating and the tapered projections into the tapered holes.

16. The object crushing system of claim 15, wherein the tapered projections include multiple tapering angles.

17. The object crushing system of claim 15, wherein the tapered projections have pyramidal shapes.

18. The object crushing system of claim 15, wherein the holes are conical shaped.

19. The object crushing system of claim 15, wherein the holes of the grating comprise conical shaped projections.

20. The object crushing system of claim 15, wherein the holes of the grating comprise pyramidal shaped projections.

21. The object crushing system of claim 15, wherein:
the crushing surface and grating are configured to crush garlic.

22. The object crushing system of claim 15, wherein:
the crushing surface and grating are configured to extract juice from the crushed object.

23. The object crushing system of 15, wherein:
the crushing surface and grating are configured to eject pieces of the crushed object through the grating.

24. The object crushing system of 15, wherein:
the projections at least as long as the holes to eject pieces of the crushed object through the grating.

25. The object crushing system of claim 15, wherein:
the crushing surface and grating are configured to slice the object placed on the crushing surface.

26. The object crushing system of claim 15, further comprising:
a plunger top attached to the surface covered with tapered projections;
a barrel of an injector; and
an adaptor of the injector attached to the grating.
